(19) United States
(12) Patent Application Publication
(10) Pub. No.: US 2015/0070169 A1
(43) Pub. Date: Mar. 12, 2015

(54) Personal Possession Alarm

(71) Applicants: Alistair Ross-Mowat, Newton Abbot (GB); Kenneth Michael Eddy, Paignton (GB)

(72) Inventors: Alistair Ross-Mowat, Newton Abbot (GB); Kenneth Michael Eddy, Paignton (GB)

(21) Appl. No.: 14/025,133

(22) Filed: Sep. 12, 2013

(51) Int. Cl. G08B 13/24

(52) U.S. Cl. CPC G08B 13/2402
USPC 340/572.1

(57) ABSTRACT

The Personal possession alarm comprises of a fob and a receiver. The fob is a portable wireless device while the receiver is fixed to the personal possession. Both the fob and the receiver are made up of rigid plastic with the electrical components enclosed. At present the system provides three function options:

1: Proximity Detection—when a preset distance between the fob and the receiver is exceeded, the system will trigger an alarm on both the fob and receiver.

2: Movement Detection—when the personal possession is disturbed, the system will trigger an alarm on both the fob and receiver.

3: Both functions can operate simultaneously.

As the alarm alerts the user of the possible theft or disturbance of the possession, it also forces the thief to abandon the possession. This device could be effectively adhered to a wide variety of personal possessions.

### GENERAL INFORMATION OF INVENTION

This invention relates to a method and device for a personal possession theft prevention apparatus. Moreover, it pertains specifically to such apparatus with the following general description: The present invention relates to a method and device for a theft prevention apparatus, in particular, an anti-theft and disturbance alarm system used for personal possessions. The said alarm system, when installed to your personal possession, ensures the safety of the article by sounding an alarm at times of disturbance or theft. The Personal possession alarm system comprises of a fob and a receiver device. The fob is a handy portable wireless device while the receiver is fixed to the personal possession by an appropriate means, such as clamps. Both the fob and the receiver are made up of rigid plastic or the like with the electrical components enclosed. At present the system provides three function options:
Function 1: Proximity Detection—when a preset distance between the fob and the receiver is exceeded, the system will trigger an alarm on both the fob and receiver.
Function 2: Movement Detection—when the personal possession is disturbed, the system will trigger an alarm on both the fob and receiver.
Function 3: Both functions can operate simultaneously.

As the alarm alerts the user of the possible theft or disturbance of the possession, it also forces the thief to abandon the possession, thus preventing the loss of the possession. This device could be effectively adhered to a wide variety of personal possessions.

### SUMMARY OF THE INVENTION

In view of the limitations now present in the prior art, the present invention provides a new and useful method, which is simpler in construction, more universally usable and versatile in operation than known apparatus of this kind.

The purpose of the present invention is to provide new and novel features not extrapolated in prior art; hence resulting in a new concept which is not apparent, obvious, or suggested, either directly by any of the prior art apparatus.

Purpose or Function: Concept relates to a method and device for a personal possession theft prevention apparatus.

Physical Description: The present invention relates to a method and device for a theft prevention apparatus, in particular an anti-theft and disturbance alarm system used for personal possessions. The said apparatus comprises of a fob and a receiver device. The fob further comprises of an ON/OFF button, and another button to switch between the functions (listed below), LED for ON/OFF, a battery, and an audible alarm. The receiver further comprises of a rechargeable battery with charge indicator, a socket to accommodate battery recharging, LED, a signal receiver to receive signals sent by the fob, an ON/OFF activation point, and an audible alarm. The alarm system is first ‘woken up’ by pressing a button on the receiver, and then the receiver is activated by pressing a button on the fob. At present the device provides three functions:
Function 1: Proximity Detection—when a preset distance between the fob and the receiver is exceeded, the system will trigger an alarm on both the fob and receiver.
Function 2: Movement Detection—when the personal possession is disturbed, the system will trigger an alarm on both the fob and receiver.
Function 3: Both functions can operate simultaneously.

As the alarm alerts the user of the possible theft or disturbance of the possession, it also forces the thief to abandon the possession, thus preventing the loss of the possession. This device could be effectively adhered to a wide variety of personal possessions.

The foregoing has outlined, in general, the physical aspects of the invention and is to serve as an aid to better understanding the more complete detailed description, which is to follow. In reference to such, there is to be a clear understanding that the present invention is not limited to the method or detail of construction, fabrication, material, or application of use described and illustrated herein. Any other variation of fabrication, use, or application should be considered apparent as an alternative embodiment of the present invention.

### OBJECTS OF THE INVENTION

Accordingly several advantages and objects of the present invention are:

A principal object of the present invention is to overcome the deficiencies of prior art devices.

An object of the present invention: relates to a method and device for a personal possession theft prevention apparatus that: Provides a method and device for a personal possession theft prevention apparatus that is easier to install than the existing system.

An object of the present invention: relates to a method and device for a personal possession theft prevention apparatus that: Provides a method and device for a personal possession theft prevention apparatus that is light-weight and easier to use than the existing system.

Another object of the present invention: relates to a method and device for a personal possession theft prevention apparatus that: Provides a method and device for a personal possession theft prevention that complies with possession better than the conventional system.

Another object of the present invention: relates to a method and a device for a personal possession theft prevention apparatus that is more universally functional in today's market than the prior art devices

It is intended that any other advantages and objects of the present invention that become apparent or obvious from the detailed description or illustrations contained herein are within the scope of the present invention.

### BRIEF DESCRIPTION OF THE DRAWINGS

The following drawings further describe by illustration the advantages and objects of the present invention. FIGS. 1, 2, 3 and 4 are perspective views of the present invention: Personal Possession Alarm.

FIG. 1 is a front view of the alarm and fob, and shows the alarm working as a proximity alarm, with the alarm remaining quiet while it is in the set proximity of the fob, and also showing the alarm in action, sounding an alarm when it is moved outside the set proximity of the fob.

FIG. 2 is a front view of the alarm and fob, and shows the alarm working as a movement detection device, with the alarm remaining quiet if undisturbed, and also showing the alarm in action if the possession it is attached to is removed or disturbed without the owner's permission.

FIG. 3 is a front view of the alarm and fob, and shows alarm features.

FIG. 4 is a back view of the alarm and fob and shows alarm features.

### DETAILED DESCRIPTION OF THE INVENTION

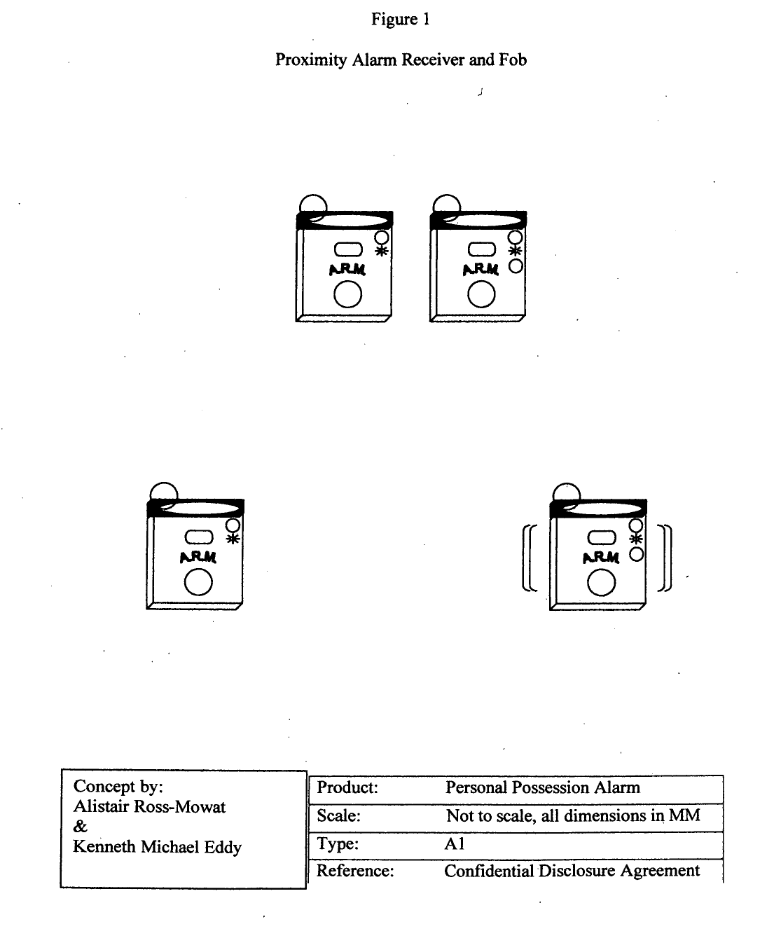

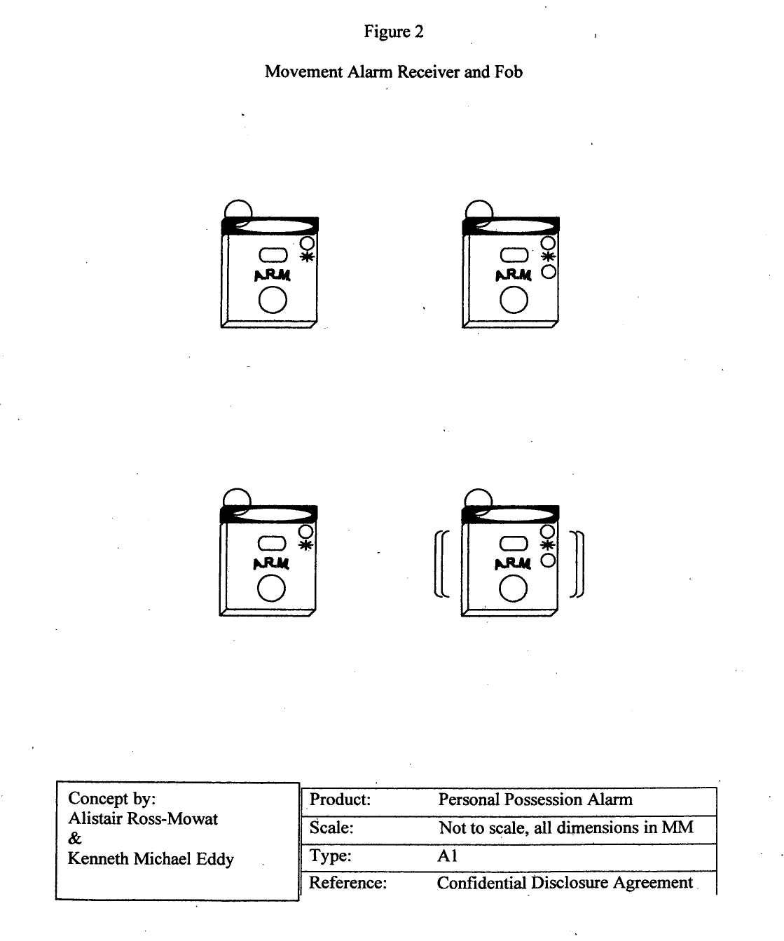

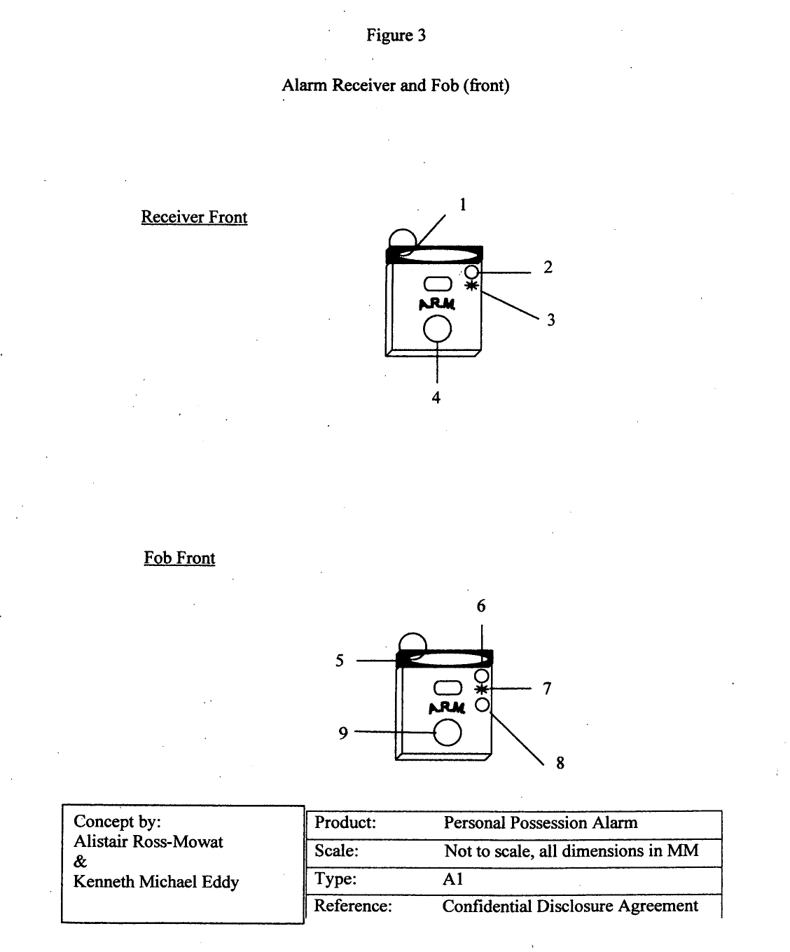

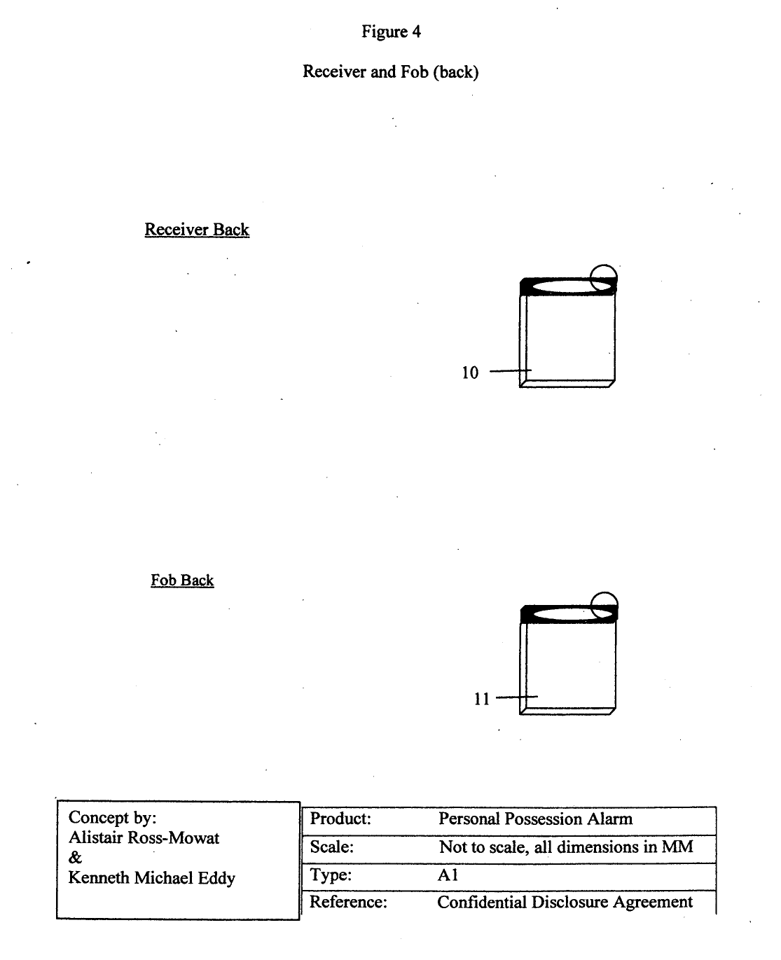

Referring now descriptively to the drawings, the attached figures illustrate a Personal Possession Alarm. FIGS. 1, 2, 3 and 4 illustrate: Personal Possession Alarm according to the present invention.

The present invention relates to a method and device for a theft prevention apparatus, in particular an anti-theft and disturbance alarm system used for personal possessions. The said apparatus comprises of a fob and a receiver device. The receiver comprises of a rigid plastic casing containing a hole with a keyring (1), an On/Off button (2), and LED to indicate activation (3), and a loud audible speaker (4). The fob further comprises of a rigid plastic casing containing a hole with a keyring (5), an ON/OFF button (6), an LED to show activation (7), and a function button (8) to switch between the functions (listed below), and a loud audible speaker (9). The back of the receiver comprises of the battery compartment (10). The back of the fob also comprises of a battery compartment (11). To use the personal possession alarm, you would first push the button on the receiver (2), then you would push the On/Off button on the fob (6), which sends a signal to the receiver, which activates the alarm. At present the device provides three functions:
Function 1: Proximity Detection—when a preset distance between the fob and the receiver is exceeded, the system will trigger an alarm on both the fob and receiver.
Function 2: Movement Detection—when the personal possession is disturbed, the system will trigger an alarm on both the fob and receiver.
Function 3: Both functions can operate simultaneously.

As the alarm alerts the user of the possible theft or disturbance of the possession, it also forces the thief to abandon the possession, thus preventing the loss of the possession. This device could be effectively adhered to a wide variety of personal possessions.

The foregoing has outlined, in general, the physical aspects of the invention and is to serve as an aid to better understanding the more complete detailed description, which is to follow. In reference to such, there is to be a clear understanding that the present invention is not limited to the method or detail of construction, fabrication, material, or application of use described and illustrated herein. Any other variation of fabrication, use, or application should be considered apparent as an alternative embodiment of the present invention.

What we claim as our invention is:

1. a personal possession alarm device comprising:
an alarm that is attached to a bag strap or similar equipment that will detect movement or removal of personal possession from a set location, sending a signal to a separate receiver fob to alert the owner of personal possession to the movement or removal of personal possession, whilst emitting a high-pitched alarm noise to deter the thief from proceeding with the theft.
